(19) United States
(12) Patent Application Publication
(10) Pub. No.: US 2008/0190207 A1
(43) Pub. Date: Aug. 14, 2008

(54) Ring oscillating digital pressure sensor manufactured by micro-electromechanical system (MEMS) processes

(76) Inventor: James Y. Yang, Cupertino, CA (US)

Correspondence Address: Bo-In Lin, 13445 Mandoli Drive, Los Altos Hills, CA, 94022, US

(21) Appl. No.: 11/704,817

(22) Filed: Feb. 8, 2007

(51) Int. Cl. G01L 19/04; G01L 9/00

(52) U.S. Cl. 73/708; 73/754

(57) ABSTRACT

A micro-electromechanical (MEMS) device functioning as a pressure sensor-that includes plurality of metal oxide semiconductor (MOS) transistors supporting on a membrane formed by an MEMS process for measuring a resistance change induced by a pressure change on the MOS transistors through the membrane for sensing the pressure change. The membrane further includes a silicon membrane covering an open space etched in a silicon substrate

### BACKGROUND OF THE INVENTION

1. Field of the Invention

The present invention is generally related to device configuration and method of fabrication employing the micro-electromechanical systems (MEMS) technologies for providing pressure-sensing device. More particularly, this invention is related to device configuration and fabrication methods by applying the MEMS processes to form pressure sensors using ring resonators for generating output frequency as function of pressure induced stress.

2. Description of the Related Art

Conventional technologies of measuring tire pressure changes are still faced with the difficulties that such measurements generally produce analog output and the analog signals are more difficult to transmit and process. Many prior art tire pressure monitor system are manufactured by assembling multiple chips. However, such assembled systems are more complex and difficult to manufacture. Furthermore, it is often difficult to provide digitized output signals through such assembled systems. Furthermore, the assembled signals require particular packaging configurations to shield such systems from the force asserted onto the system induced by the pressure. Additional difficulties also involve the measurement deviations caused by temperature variations. Also, the noises caused by the metal wires embedded in the tire, the interferences of electrical field caused by rotation of these metal wires are further technical difficulties faced by the designer and manufacturers of the tire pressure monitoring systems.

Therefore, the conventional technologies of tire pressure monitor systems and method of manufacturing are still unable to resolve the difficulties and limitations discussed above. A need still exists in the field of pressure sensing technology to provide new and improved system and methods to overcome such technical difficulties and limitations.

### SUMMARY OF THE INVENTION

According it is an object of the present invention to provide a MEMS device that includes a pressure sensor disposed on a silicon substrate. In an exemplary embodiment, this invention discloses a pressure sensor that includes a micro-electromechanical (MEMS) device further includes a plurality of metal oxide semiconductor (MOS) transistors supporting on a membrane formed by an MEMS process for measuring a resistance change induced by a pressure change on the MOS transistors through the membrane for sensing the pressure change. In another exemplary embodiment, the electronic device is disposed on a membrane subject to the pressure change for asserting a stress onto the electronic device for generating the frequency output in response to the stress

Specifically, the pressure sensor is manufactured by applying the MEMS process disclosed in this invention. In a preferred embodiment, this invention discloses a method for measuring a pressure change. The method includes a step of forming a micro-electromechanical (MEMS) device by disposing a plurality of metal oxide semiconductor (MOS) transistors on a membrane by applying an MEMS process for measuring a resistance change induced by a pressure change on said MOS transistors through said membrane for sensing said pressure change.

These and other objects, features and advantages of the present invention will no doubt become apparent to those skilled in the art after reading the following detailed description of the preferred embodiments that are illustrated in the several accompanying drawings.

### BRIEF DESCRIPTIONS OF THE DRAWINGS

The present invention can be better understood with reference to the following drawings. The components within the drawings are not necessarily to scale relative to each other, emphasis instead being placed upon clearly illustrating the principles of the present invention.

FIG. 1A is a top view of a MOS transistor subject to a stress induced by a pressure.

FIG. 1B is a cross sectional view of a membrane supported on a silicon substrate for placing the MOS transistor on the membrane.

FIG. 2 is a functional block diagram for showing the configuration of a pressure sensing device of this invention.

FIG. 3 is a circuit diagram for showing the structure of a ring resonator implemented with MOS transistors to form a multiple stages of inverters.

FIG. 4 is circuit diagram for showing a double gate mixer implemented in the pressure sensing device of this invention.

FIGS. 5A and 5B are top view and side cross sectional view of a pressure sensor formed on a silicon substrate according to a configuration of FIG. 2.

FIGS. 6A to 6D are a serial of side cross sectional views for showing the processing steps applied to form a pressure sensing device of FIG. 6A and 6B.

FIGS. 7A and 7B are diagrams of ring resonator output frequencies of horizontal and vertical resonators as function of pressure.

FIG. 8 is a diagram for showing the output frequency changes as the function of force applied to the pressure-sensing device shown in FIGS. 6A and 6B.

### DETAILED DESCRIPTION OF THE PREFERRED EMBODIMENTS

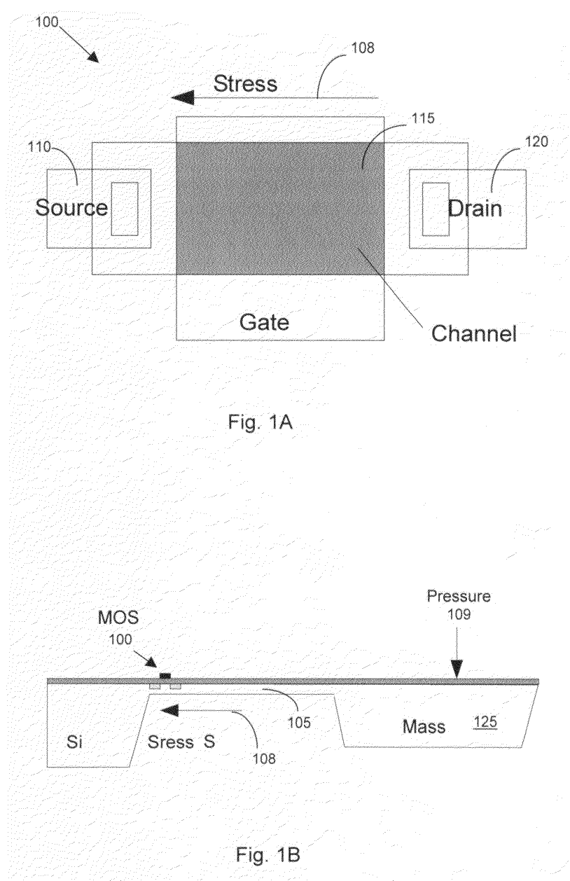

Referring to FIGS. 1A and 1B for pressure sensor implemented with a MOS transistor 100 supported on a silicon membrane 105. The pressure changes are measured through the changes of the resistance in the MOS transistor 100 when a stress 108 is applied to the transistor 100 when a pressure change applies a force to the silicon membrane 105. As the stress 108 is asserted on the transistor 100, the stress causes a change in the migration speed of the charge carrying particles. These charge particles can be either electrons or ions of positive charges conducting through the channel 115 between the source 110 and the drain 120 of the transistor 100. The change in the migration speed of the charge particles causes a change of the resistance of the transistor.

The change of resistance induced by the application of a stress onto the transistor is depending on the direction of the force and the crystal orientations of the transistor and the channel. For example, in a PMOS transistor 100 formed along a (100) crystal orientation of a silicon substrate, if a stress is applied along a direction parallel to the (110) crystal orientation as shown in FIG. 1B, then the migration speed is increased in a channel formed along the (110) crystal orientation. Conversely, the migration speed is decreased in a channel formed along a (100) crystal orientation. These changes of migration speed change the current conduction characteristics including the resistance of the MOS transistor. A pressure change can therefore be detected and measured by measuring the changes of the resistance either directly or indirectly. Indirect measurements of the pressure changes can be performed indirectly through the changes of a specific device parameter related to the changes of the resistance. The device is implemented with the MOS transistor 100 that is subject to a pressure change that causes the stress to assert onto the transistor. As shown in FIG. 1B, a pressure 109 is applied to a supporting structure showing as a substrate carrier 125, the silicon membrane 105 is bent slightly thus asserting a stress 108 onto the transistor 100.

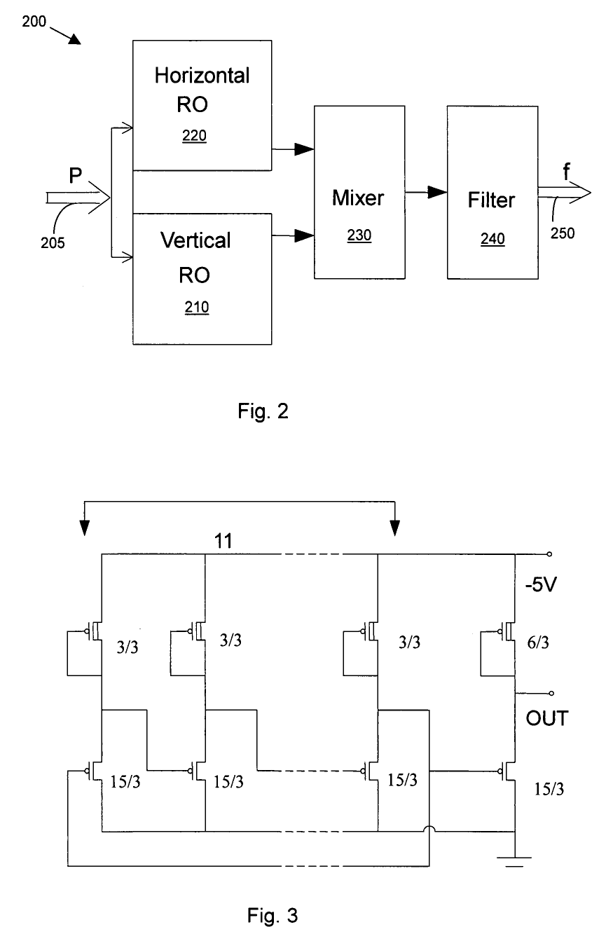

Referring to FIG. 2 for a functional block diagram of a digital pressure sensor 200 of this invention. For the purpose of measuring a pressure change, the digital pressure sensor 200 is implemented with a ring resonator that includes a horizontal resonator 210 and vertical ring resonator 220 to generate signals of resonating frequencies. The output signals of the ring resonators 210 and 220 are then mixed in a mixer 230. The mixed signals are further filtered through a output signal filter 240 to generate an output frequency 250. The changes of the output frequency 250 provide a measuring parameter to measure the changes of the pressure. Specifically, in a preferred embodiment, the horizontal and vertical ring resonator 210 and 220 are identical resonators disposed in a pressure sensing area to receive a pressure 205. For example, these resonators are disposed on silicon membrane as shown in FIG. 1B and the silicon membrane is placed on area exposed to pressure changes. As the pressure 205 are impressed on the ring resonators, the frequencies of these two resonator are changed because the changes of resistances taking place inside the MOS transistors that are implemented in these resonators.

As the pressure changes occurs, the stress is impressed on these two resonators 210 and 220 with the MOS transistors along a parallel to the transistor channel and perpendicular to channel directions. The pressure changes thus cause on resonator to increase in resonator frequency and another resonator to decrease in resonator frequency. These changes of resonator frequencies are received into the mixer 230 to carry out a subtraction operation. The signals output from the mixer 230 is further filtered to eliminate the signals of the higher order of harmonic resonant frequencies thus generate the output signal 250 with a specific output frequency to clearly indicate a measurement of pressure changes.

The pressure sensor as shown in FIG. 2 has several advantages. First advantage is provided by its conversion of the analog measurement of pressures into a frequency measurement. Compared to a pressure measurement, it is much more convenient and easier to digitize the frequency measurement. Since the ring resonators are exposed to the changes of the pressure, the structure is significantly simplified because no shielding protections of the sensor from the pressure are required. As the manufacturing processes will be further described below, it can be clearly understood that the application of the MEMS technologies has greatly simplified the manufacturing processes and also substantially increase the reliability and quality of the pressure sensors. The application of a signal mixer 230 reduces the temperature effect thus greatly increases the pressure change measurements by removing the measurement error caused by the temperature measurement deviations. With the operations of the mixer 230 and the filter 240, the signal noises and errors introduced from both from common mode base frequency resonance and high order harmonic resonance are removed. The output frequency 250 thus provides an accurate and clean signal of pressure changes.

Referring to FIG. 3 for a PMOS ring oscillator that includes odd number of stages of inverters, e.g., eleven stages of invertors shown in FIG. 3, with the last stage connected to the first stage thus forming a ring oscillator. The resonating frequency is a function of the delay time of the inverter and the number of stages of this ring resonator. Specifically, the functional relationship can be further explained by the following equations:

$$f = \frac{1}{2 n {τ}_{PD}} \qquad ( 1 )$$

Where n stands of number of stages of inverters, τ_{PD} stands for the delay time of the inverter. The delay time may further be represented as function of the rising time tᵣ and falling time t_{f} as equations (2) to (4) below:

$$\begin{matrix}{τ}_{PD} = \frac{{t}_{r} + {t}_{f}}{2} & ( 2 ) \\ {t}_{r} = \frac{2 {C}_{L}}{μ {C}_{OX}} {f}_{r} ( V ) & ( 3 ) \\ {t}_{f} = \frac{2 {C}_{L}}{μ {C}_{OX}} {f}_{f} ( V ) & ( 4 )\end{matrix}$$

Where C_{L} stands for a load capacitance of the inverter; C_{OX} stands for the gate capacitance of the inverter; fᵣ(V), and f_{f}(V) are functions of the working voltage V. According to above equations, the resonating frequency of the ring resonator may be represented as function of the migration rate of the transistor as shown below:

$$f = μ \frac{{C}_{OX}}{2 n {C}_{L}} \frac{1}{{f}_{r} ( V ) + {f}_{f} ( V )} \qquad ( 5 )$$

According to above equation, the resonating frequency of the ring resonator is proportional to the migration rate of the transistor. In the meantime, the migration rate of the transistor is proportional to the stress induced by the pressure impressed on the transistor. Therefore, by detecting the changes of the resonating frequency, the pressure can be accurately measured.

The ring resonator as shown above can be implemented with NMOS, PMOS and CMOS transistors. The NMOS implementation has the advantage of simpler manufacturing processes. However, the output parameter generated from a ring resonator implemented with NMOS transistor suffers a loss of signal amplitudes leads to significant increase of signal to noise ratio and therefore does not provide sufficient quality for accurate pressure measurement. In contrast, a CMOS ring resonator can provide output of a best quality. However, the processing steps of the CMOS ring resonator are more complicate. For these reasons, in a preferred embodiment, the ring resonator of this invention is implemented with PMOS transistors. In comparison to NMOS transistors, the PMOS transistors have better pressure sensitivities. The ring resonator implemented with the PMOS transistors is more responsive to pressure changes. Furthermore, the PMOS ring resonator is less sensitive to temperature variations and therefore provide more stable and more accurate measurements. Comparing to CMOS transistors, the PMOS ring resonators have less complicate manufacturing processes and can be produced with higher yields. A ring resonator as shown in FIG. 3 has eleven stages to generate a sine shaped wave with a resonating frequency of 1.5 Hz and an output amplitude of approximate two volts.

When a pressure change occurs, the response of the horizontal resonator 210 is different from the response of the vertical resonator 220. The frequency of the vertical resonator 220 is increased with the increase of the pressure while the frequency of the horizontal resonator is decreased in response to the pressure increase as shown in the Equations (6) and (7) respectively below:

f₁=f₀+Δf₁+f₁(T) (6)

fₜ=f₀−Δfₜ+fₜ(T) (7)

Where f₀ is resonating frequency of the resonators and Δf₁ and Δfₜ are the frequency changes caused by the change of pressure, and f₁(T) and fₜ(T) are coefficients of temperature of the resonator frequency. For two identical resonators, these two resonator have a same coefficient of temperature for these two resonator are also the same and f₁(T)=fₜ(T). By subtracting Equation (7) from Equation (6), a net frequency change is obtained as:

f=f₁−fₜ=Δf₁+Δfₜ (8)

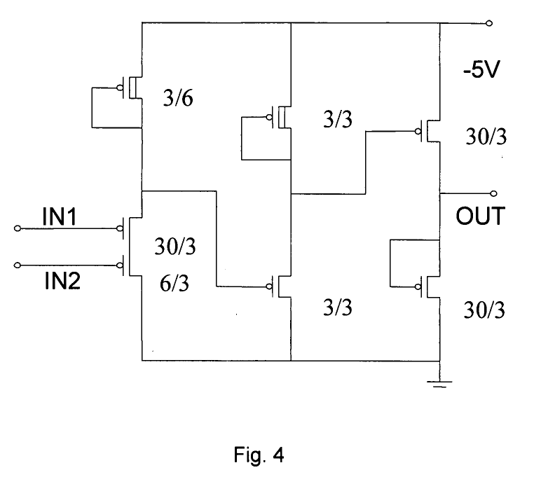

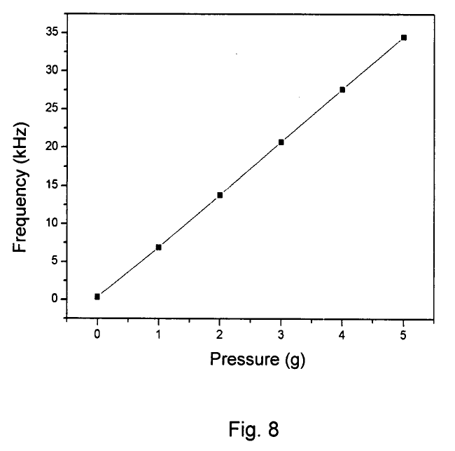

There are several advantages of measuring a pressure change by employing a net frequency change as shown in FIG. 8. First of all, the net frequency change can provide a measurement that has almost no or only minimal effects caused by temperature changes. Because in the net frequency measurement, the temperature effects are canceled out in subtracting the frequency changes measured by the horizontal and vertical resonators. Furthermore, the inaccuracies or biases of a base mode frequency measurement, i.e., the measurement of f₀, are also canceled out and the measurement is more responsive to the pressure changes. For the purpose of measuring a net frequency change according to Equation (8), a frequency mixer is implemented as shown in FIG. 4. Instead of conventional mixer designs implemented with inductors and capacitors, FIG. 4 shows a mixer implemented with transistors. The mixer as shown in FIG. 4 is a double-gate MOS mixer that receives two input signals shown as IN1 and IN2. A voltage source of −5 volts is connected to the mixer to provide a DC bias to generate an output signal OUT. In a specific embodiment, the input signals have frequencies around 2 Mhz, and the net frequency change generated by the mixer is between zero to one Mhz with an output amplitude around 0.5 volts. The wave-mixing capabilities of the mixer of FIG. 4 are less effective in mixing either the square waves or triangular waves. Much improved mixing results are achieved with input signals of sine waves. The mixer of FIG. 4 provides excellent wave mixing function when connected to the horizontal and vertical resonators as that shown in FIG. 2.

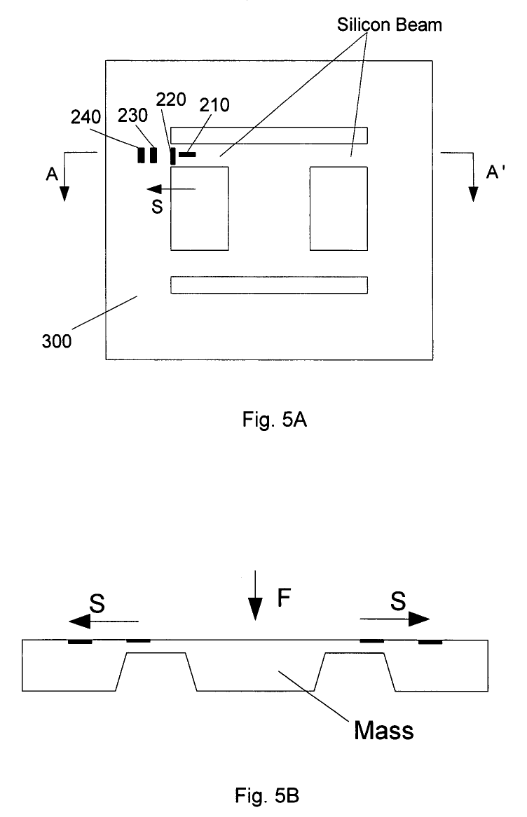

Referring to FIG. 5A and 5B for a top view and a cross sectional view of the structure of a pressure sensing device disposed on a silicon substrate 300. FIG. 5B is a cross sectional view along the A-A′ cross sectional line of FIG. 5A. The substrate 300 is formed with four silicon membranes with a membrane supports the horizontal and vertical resonators 210 and 220 connected to the mixer 230 and the filter 240. In a preferred embodiment, the membrane has a length of 2000 micrometers, a width of 400 micrometers and a thickness of 15 micrometers. Compared to the conventional pressure sensor supported with a two membrane structure with biased pressure sensitivity along the horizontal direction, the pressure sensing device as shown has more balance pressure sensitivities. Meanwhile, the four-membrane structure does not have the problems of difficult manufacturing processes due to the complicate structures. As the pressure is applied onto the pressure-sensing device supported on the substrate 300, a stress shown as S is induced. The stress S induced frequency changes on the ring resonator 210 and 220. The mixer 230 generates the net frequency change. The filter 240 filters the net frequency signals to remove additional noises and signals of higher order harmonic resonant frequencies to provide an output measurement of the pressure change.

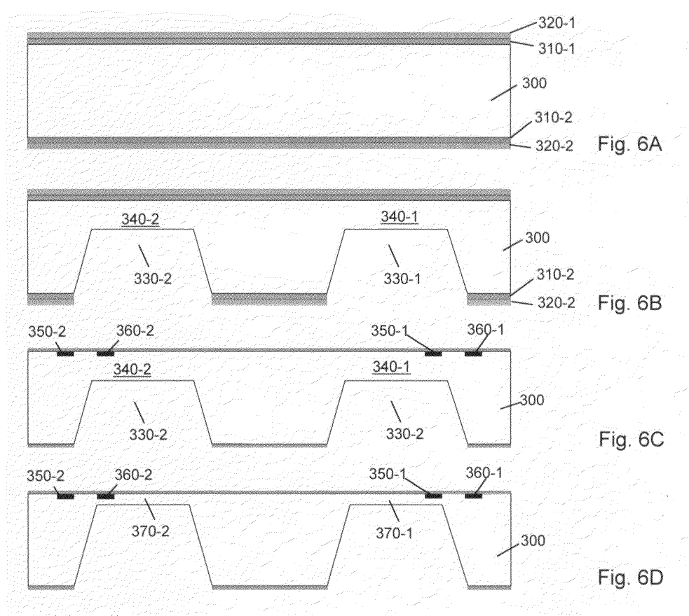

FIGS. 6A to 6D illustrate the manufacturing process of the pressure sensor implemented with the ring resonator as shown in FIGS. 1 and 2. In FIG. 6A, a silicon oxide layer 310-1 and 310-2 of a thickness about 3000 Angstroms are grown on the top and bottom surfaces respectfully of a silicon substrate 300 with a crystal orientation of (100). Then silicon nitride layers 320-1 and 320-2 with a thickness of approximately 2000 Angstroms are deposited on the top and the bottom surfaces respectfully over the silicon oxide layers 310-1 and 310-2. In FIG. 6B, a lithographic etch is carried out on the silicon nitride and silicon oxide layer 310-2 and 320-2 respectively to open an etch window. Then a silicon KOH etch is carried out over the etch windows to form the silicon membrane structure with bottom cavity 330-1 and 330-2 as shown in FIG. 6B. The membranes 340-1 and 340-2 over the cavities 330-1 and 330-2 have a thickness of about one hundred micrometers. The KOH applied to etch the cavities 330-1 and 330-2 has a weight percentage of about 33%. The etch process is carried out around a temperature of 80° C. The silicon oxide layers and the silicon nitride layers 310 and 320 function as protective layer to protect the silicon from being etched by the KOH during this cavity etching process. In FIG. 6C, standard semiconductor EDPMOS processes are applied to form the ring resonators 350-1 and 350-2 and the mixers 360-1 and 360-2. In one exemplary EDPMOS process to form these devices involves five lithographic etching processes, four dopant ion implantations, three thermal oxide growth processes, one low pressure chemical vapor deposition (LPCVD) process and one silicon oxide growth and one silicon nitride deposition processes. The final steps involve an aluminum sputtering and the aluminum wire bonding processes. In FIG. 6D, an an-isotropic etch process is carried out on the bottom of the substrate 300 to reduce the thickness of the membrane 370-1 and 370-2 to a thickness of about 15 micrometers. These membranes 370-1 and 370-2 are sensitive to the pressure and generate a stress onto the resonators 350-1 and 350-2 when there is a pressure variation. The above processes provide accurate control over the thickness of the membranes 370-1 and 370-2 by first opening the cavities to make membranes of about 100 micrometers. Then a second an-isotropic etching process that has a slower etching speed is performed to further reduce the thickness with a very accurate thickness control to about 15 micrometers.

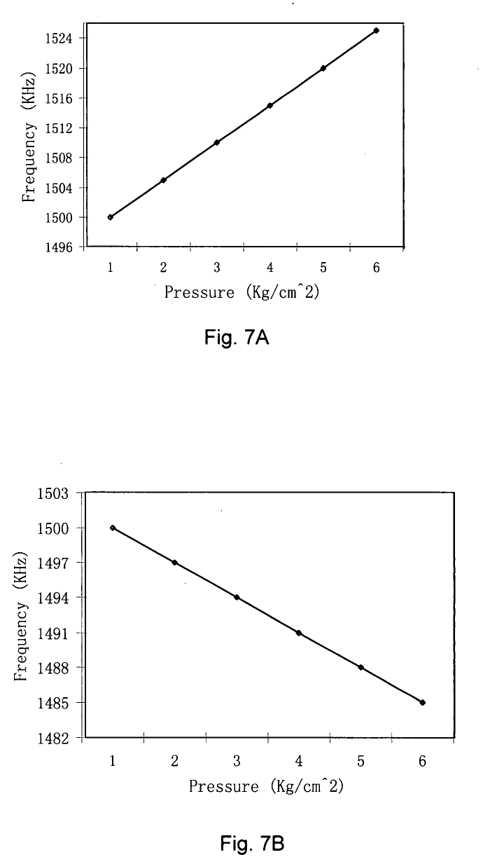

FIGS. 7A is a diagram for showing the increase of frequency of a vertical resonator in response to the increase of stress that has an increasing rate of about 3.46 KHz/g. FIG. 7B shows the decrease of frequency of a horizontal resonator in response to the increase of stress that has an decreasing rate of about −3.45 KHz/g. FIG. 8 is a diagram for showing the output frequency of the pressure sensor as a function of pressure. The filter is implemented as a separate device not integrated on the silicon substrate. In one exemplary embodiment, the pressure sensor is calibrated at a zero point to generate an output frequency of 350 Hz with a rate of change at 6.91K Hz/g.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A micro-electromechanical (MEMS) device functioning as a pressure sensor comprising:
a plurality of metal oxide semiconductor (MOS) transistors supporting on a membrane formed by an MEMS process for measuring a resistance change induced by a pressure change on said MOS transistors through said membrane for sensing said pressure change.

2. The MEMS device functioning as a pressure sensor of claim 1 wherein:
said membrane further comprising a silicon membrane covering an open space etched in a silicon substrate.

3. The MEMS device functioning as a pressure sensor of claim 1 wherein:
said pressure change further applying a stress on said membrane for inducing a change of charge migration speed in said MOS transistors and said resistance change corresponding to said change of charge migration speed.

4. The MEMS device functioning as a pressure sensor of claim 1 wherein:
said MOS transistors further comprising a PMOS transistor formed along a (100) crystal orientation of a silicon substrate for inducing a stress along a direction parallel to the (110) crystal orientation due to said pressure change for increasing a charge migration speed along said (110) crystal orientation thus changing a resistance in said PMOS transistor.

5. The MEMS device functioning as a pressure sensor of claim 1 wherein:
said MOS transistors further constituting a ring resonator for generating a signal of a resonating frequency with said resonating frequency changed with said resistance change corresponding to said change of pressure.

6. The MEMS device functioning as a pressure sensor of claim 1 wherein:
said MOS transistors further constituting a vertical and a horizontal ring resonators for generating signals of two resonating frequencies; and
said pressure sensor further includes a mixer for mixing and filtering said signals of said resonating frequencies for generating an output signal for measuring said pressure change.

7. The MEMS device functioning as a pressure sensor of claim 1 wherein:
said MOS transistors further constituting a vertical and a horizontal ring resonators for generating signals of two resonating frequencies wherein said vertical and said horizontal ring resonators are identical resonators.

8. The MEMS device functioning as a pressure sensor of claim 1 wherein:
said MOS transistors further constituting a ring resonator for generating a signal of a resonating frequency corresponding to said change of pressure; and
an analog to digital converter (ADC) for converting said resonating frequency into a digital signal for measuring said pressure change as a digital signal.

9. The MEMS device functioning as a pressure sensor of claim 1 wherein:
said pressure change further applying a stress on said membrane for inducing a change of charge migration speed in said MOS transistors; and
said MOS transistors further constituting a ring resonator for generating a signal of a resonating frequency with said resonating frequency proportional to said charge migration speed corresponding to said pressure change.

10. The MEMS device functioning as a pressure sensor of claim 1 wherein:
said pressure change further applying a stress on said membrane for inducing a change of charge migration speed in said MOS transistors; and
said MOS transistors further constituting a PMOS ring resonator includes odd number of stages of inverters wherein said resonating frequency is a function of delay time of said inverter and a number of stages of said ring resonator.

11. The MEMS device functioning as a pressure sensor of claim 10 wherein:
said resonating frequency is a function of said delay time of said inverter and said number of stages of said ring resonator by f=1/2nτ_{PD} where n stands of number of stages of inverters, τ_{PD} stands for the delay time of the inverter.

12. The MEMS device functioning as a pressure sensor of claim 1 wherein:
said MOS transistors further constituting a NMOS ring resonator for generating a signal of a resonating frequency corresponding to said change of pressure.

13. The MEMS device functioning as a pressure sensor of claim 1 wherein:
said MOS transistors further constituting a PMOS ring resonator for generating a signal of a resonating frequency corresponding to said change of pressure.

14. The MEMS device functioning as a pressure sensor of claim 1 wherein:
said MOS transistors further constituting a CMOS ring resonator for generating a signal of a resonating frequency corresponding to said change of pressure.

15. The MEMS device functioning as a pressure sensor of claim 1 wherein:
said MOS transistors further constituting a ring resonator comprising eleven stages of generating substantially a sine wave signal of a resonating frequency about 1.5 KHz and an output amplitude of approximate two volts.

16. The MEMS device functioning as a pressure sensor of claim 1 wherein:
said MOS transistors further constituting a vertical and a horizontal ring resonators for generating signals of two resonating frequencies wherein said resonating frequency of said vertical resonator increasing with an increase of said pressure and said resonating frequency of said horizontal resonator decreasing with an increase of said pressure as represented by f₁=f₀+Δf₁+f₁(T) and fₜ=f₀−Δfₜ+fₜ(T)
Where f₀ is said resonating frequency of said resonators and Δf₁ and Δfₜ are said frequency changes caused by said pressure change, and f₁(T) and fₜ(T) are coefficients of temperature of the resonating frequency and a net frequency change is represented by f=f₁−fₜ=Δf₁+Δfₜ.

17. The MEMS device functioning as a pressure sensor of claim 16 wherein:
said measurement of said pressure change is corresponding to said net frequency change whereby a temperature effects of measurements are substantially eliminated.

18. A pressure sensor comprising:
a micro-electromechanical (MEMS) device further comprising a plurality of metal oxide semiconductor (MOS) transistors supporting on a membrane formed by an MEMS process for measuring a resistance change induced by a pressure change on said MOS transistors through said membrane for sensing said pressure change.

19. The pressure sensor of claim 18 wherein:
said electronic device is disposed on a membrane subject to said pressure change for asserting a stress onto said electronic device for generating said frequency output in response to said stress.

20. A method for measuring a pressure change comprising:
forming a micro-electromechanical (MEMS) device by disposing a plurality of metal oxide semiconductor (MOS) transistors on a membrane by applying an MEMS process for measuring a resistance change induced by a pressure change on said MOS transistors through said membrane for sensing said pressure change.
